(19) United States
(12) Patent Application Publication
(10) Pub. No.: US 2010/0154242 A1
(43) Pub. Date: Jun. 24, 2010

(54) FREEZE-DRYING APPARATUS AND DEVICE FOR LOADING AND UNLOADING OF A FREEZE-DRYING APPARATUS

(75) Inventors: Ralf Battenberg, Marburg (DE); Alexander Wagner, Lohra (DE)

Correspondence Address: HANLEY, FLIGHT & ZIMMERMAN, LLC, 150 S. WACKER DRIVE, SUITE 2100, CHICAGO, IL, 60606, US

(73) Assignee: ACCURRO GmbH, Marbach-Michelbach (DE)

(21) Appl. No.: 12/635,139

(22) Filed: Dec. 10, 2009

(30) Foreign Application Priority Data
Dec. 19, 2008 (DE) 10 2008 064 094.8

(51) Int. Cl. F26B 13/30

(52) U.S. Cl. 34/92

(57) ABSTRACT

Described in the examples herein are devices for loading and unloading of an adjusting plate of a freeze-drying apparatus with a number of vials, with a transfer table provided upstream of the freeze-drying apparatus for temporary accommodation of the vials, with a shifting device for shifting the vials from the transfer table onto the adjusting plate or from the adjusting plate onto the transfer table, and with a right and/or left side limit. According to one example, the creation of a device, so that the vials can be brought into and out of the freeze-drying apparatus by maintaining their sequence and order, is achieved by the side limit being provided with elements which are movable with low friction by striking vials.

### TECHNICAL FIELD

The present invention relates to a device for loading and unloading of an adjusting plate of a freeze-drying apparatus according to the preamble of claim 1 and to a freeze-drying apparatus according to the preamble of claim 2.

### BACKGROUND

The frozen goods to be dried in a freeze-drying apparatus are filled into vials and conveyed in these vials. Caps are provided on these vials which are closed after completion of the freeze-drying process. The vials filled with the frozen goods are transferred to a transfer table in the process from where they are conveyed by means of a shifting device onto an adjusting plate into the inside of the freeze-drying apparatus. This shifting device may, for example, be a simple slider. In order that the vials do not accidentally fall down from the transfer table during transportation, the table has a side limit on its right and left exterior. The same applies to the adjusting plate within the freeze-drying apparatus because on this an adjusting plate as well side limits are provided on the right and left side so that the vials do not accidentally fall down.

When the vials are moved from the transfer table onto the adjusting plate, some of the vials come into contact with the side limit and increased friction occurs. As a result, the outer vials move more slowly than the inner vials, so that arrangement of the vials among each other is changed. In an extreme case, the one or other vial may even fall over as a result, leading to increased rejects.

### BRIEF DESCRIPTION OF THE DRAWINGS

FIG. 1 is a sectional plan view of a first example of a freeze-drying apparatus and a device for loading and unloading of an adjusting plate of the freeze-drying apparatus according to the invention cut along line I-I in FIG. 2 or 3;

FIG. 1a is a magnified detail of the device according to FIG. 1 along line I a in FIG. 1;

FIG. 2 is a sectional side view of the freeze-drying apparatus and device according to FIG. 1, cut along line II-II in FIG. 1 or 3;

FIG. 2a is a magnified detail of the device according to FIG. 1 along line II a in FIG. 2;

FIG. 3 is a sectional front view of the freeze-drying apparatus and device according to FIG. 1 cut along line III-III in FIG. 1 or 2;

FIG. 3a is a sectional magnified detail of the freeze-drying apparatus according to FIG. 1 along line III a in FIG. 3;

FIG. 3b is a sectional magnified detail of the freeze-drying apparatus according to FIG. 1 along line III b in FIG. 3;

FIG. 4 is a sectional plan view of a second example of a freeze-drying apparatus and device for loading and unloading of an adjusting plate of the freeze-drying apparatus according to the invention cut along line IV-IV in FIG. 5 or 6;

FIG. 4a is a magnified detail of the device and the freeze-drying apparatus according to FIG. 4 along line IV a in FIG. 4;

FIG. 4b is a magnified detail of the device according to FIG. 4 along line IV b of in FIG. 4;

FIG. 4c is a magnified detail of the device according to FIG. 4 cut along line IV c in FIG. 4;

FIG. 5 is a sectional side view of the freeze-drying apparatus and device according to FIG. 4 cut along line V-V in FIG. 4 or 6;

FIG. 6 is a sectional front view of the freeze-drying apparatus and device according to FIG. 4 cut along line VI-VI in FIG. 4 or 5;

FIG. 6a is a sectional magnified detail of the freeze-drying apparatus according to FIG. 1 along line VI a in FIG. 6;

FIG. 6b is a sectional magnified detail of the freeze-drying apparatus according to FIG. 1 along line VI b in FIG. 6.

### DETAILED DESCRIPTION

According to the examples described herein, the present invention provides a freeze-drying apparatus and a device of the type mentioned above so that the vials can be brought into and out of the freeze-drying apparatus by maintaining their sequence and order.

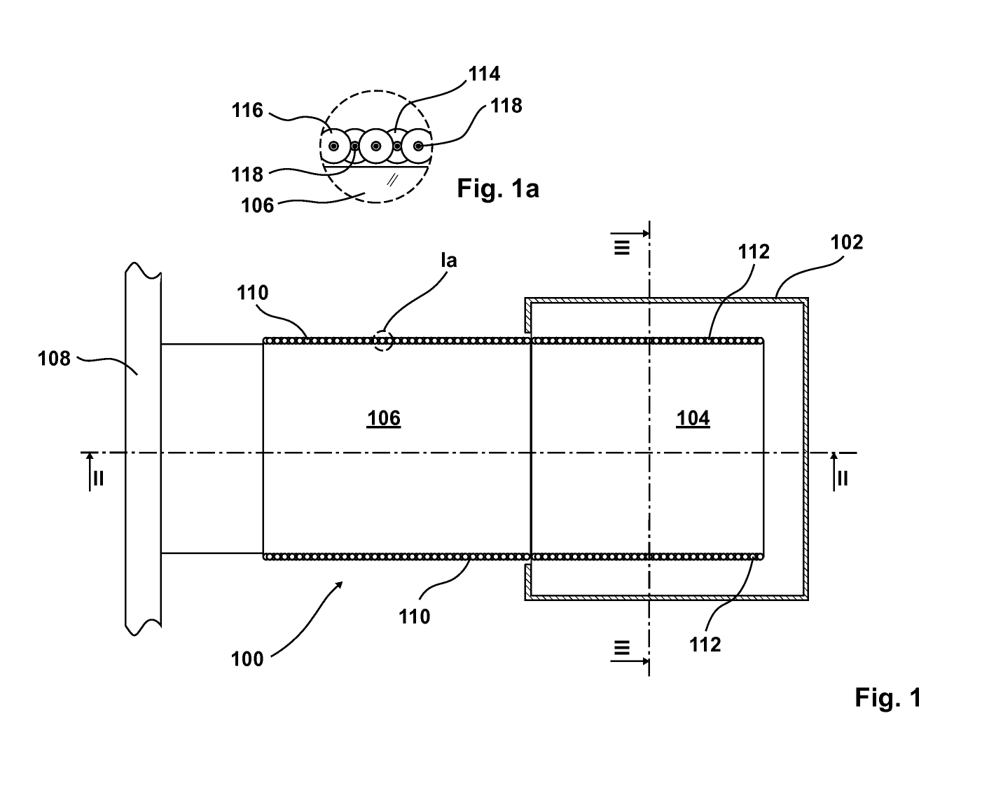

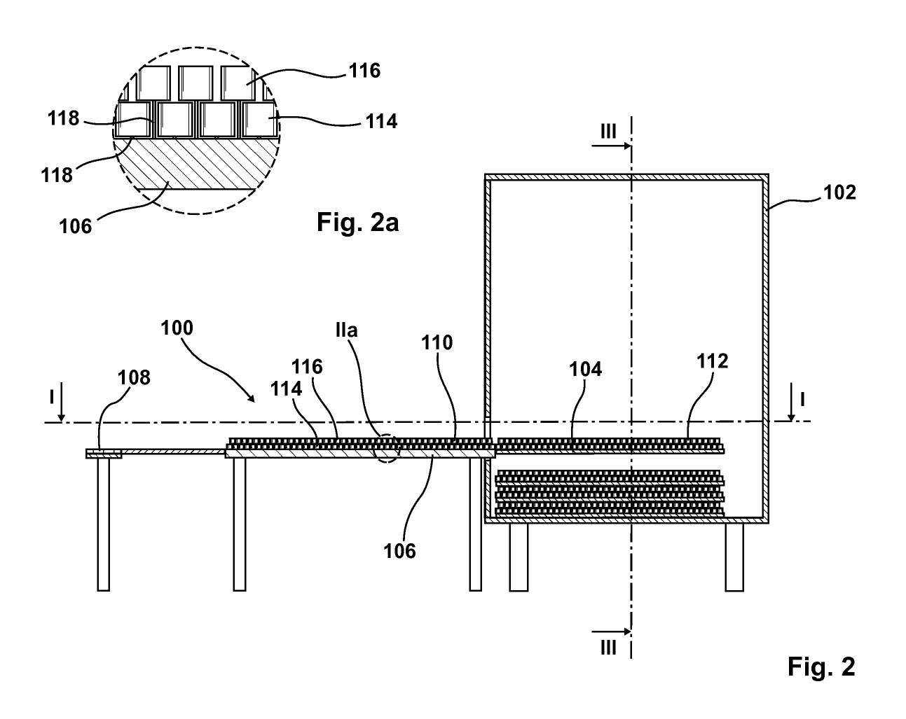

In FIGS. 1 to 3a a first example of an inventive device 100 for loading and unloading of an adjusting plate of a freeze-drying apparatus as well as a first example of an associated freeze-drying apparatus 102 is shown. Both units are only shown schematically in order to increase clearness. The freeze-drying apparatus 102 comprises some adjusting plates 104 arranged inside which are vertically movable. The device for loading and unloading of an adjusting plate arranged upstream of the freeze-drying apparatus 102 comprises a transfer table 106, a shifting device (not shown) for shifting the vials, and a handling device 108 by means of which the vials are supplied to and/or discharged from the transfer table 106.

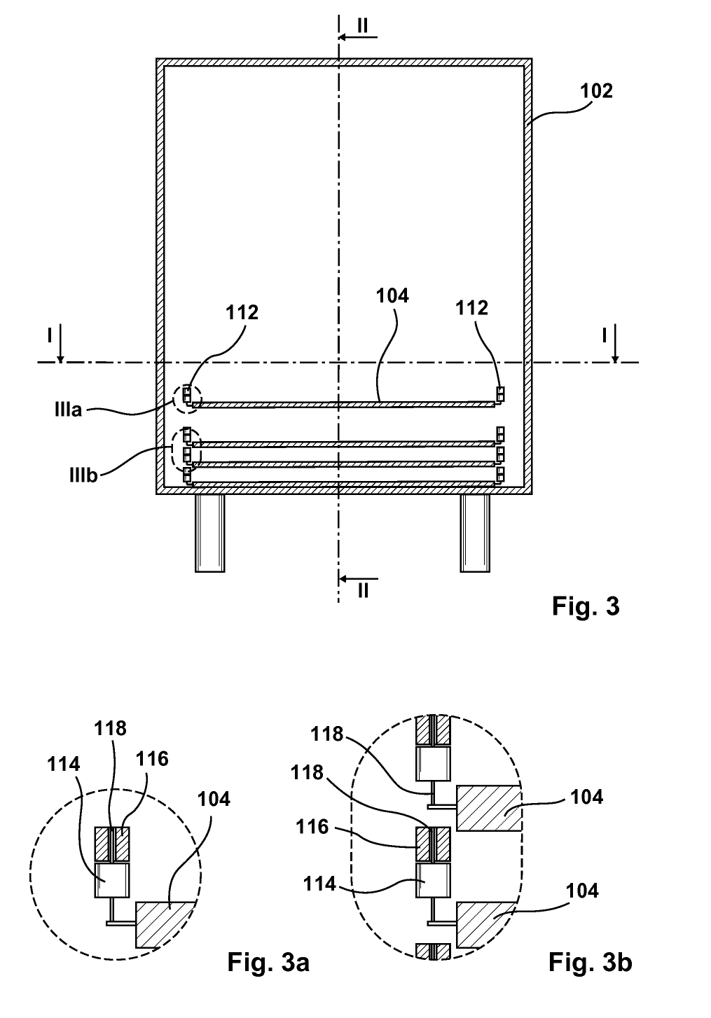

On the right and left edge of the transfer table 106 one side limit 110 each is provided preventing that the vials accidentally fall off the transfer table 106. A side limit 112 mainly identical in construction is located on the right and left edge of the adjusting plate 104. As can in particular be taken from FIG. 3 a, the side limit 112 is entirely attached next to the adjusting plate 104 so that when the vertically movable adjusting plates 104 are put together, the next adjusting plate on top can likewise get between the side limits 112 in order to stack the individual adjusting plates 104 as close as possible to each other.

The side limit 110 has a lower row of hollow cylinders 114 and an upper row of hollow cylinders 116 which are arranged such that the outermost point of its cylinder surface virtually forms the side of the side limit 110, 112. All hollow cylinders 114, 116 are arranged in a rotary manner around their vertical axis and held on a corresponding pin 118 with low friction so that a vial striking the hollow cylinder 114, 116 starts to rotate this hollow cylinder without experiencing much resistance in travel direction.

The hollow cylinders 114 of the lower row are arranged in a staggered manner compared with the hollow cylinders 116 of the upper row, as can particularly be seen in FIGS. 1 a and 2 a. Thus, a relatively high side wall of the side limit 110, 112 is created causing a low friction sliding of the vial alongside the side limit 110, 112. Due to the pivoted hollow cylinders 114, 116 relative speed between the vial to be conveyed and the side limit 110, 112 can also be reduced to a minimum in order to achieve a preferably uniform transportation of all vials.

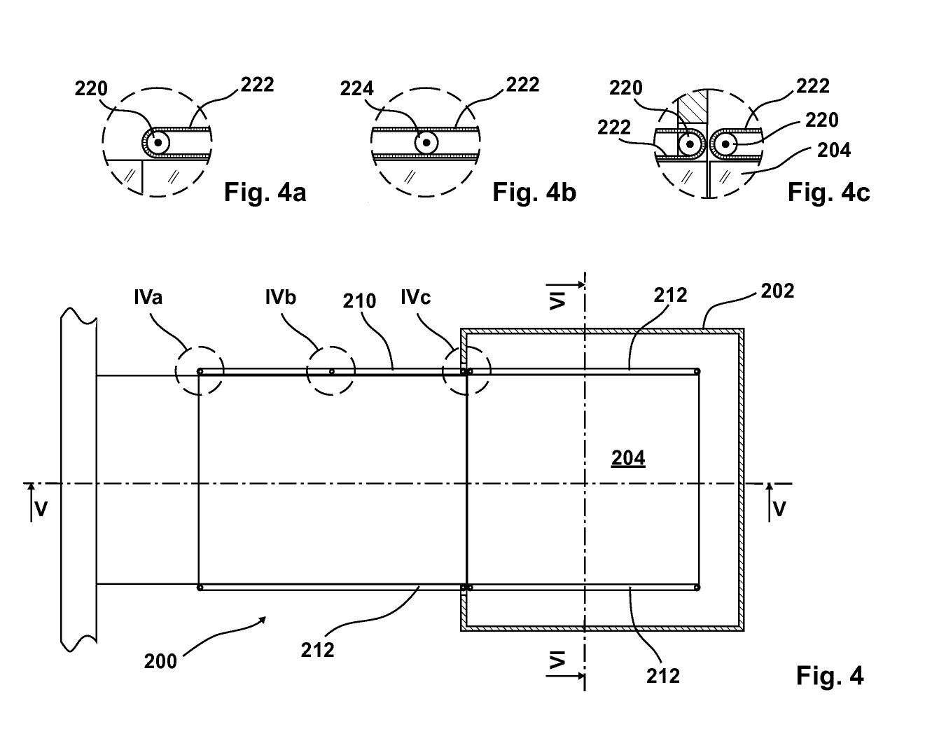

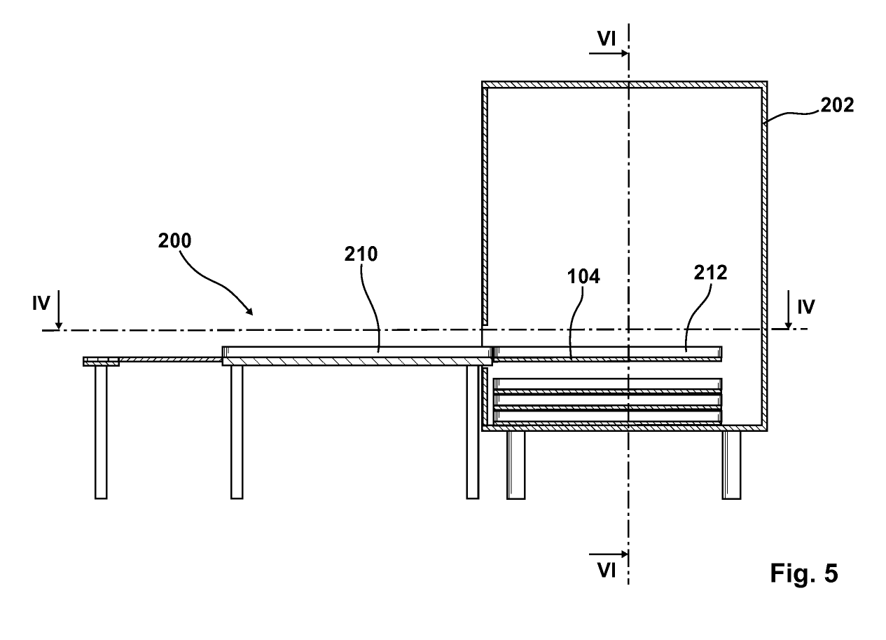

In FIGS. 4 to 6a a second example of an inventive device for loading and unloading 200 of an adjusting plate 204 of a freeze-drying apparatus 202 and a second example of an associated freeze-drying apparatus 202 is shown. Both examples are identical in construction except for the side limit 210, 212.

In this example the movable elements of the side limit 210, 212 are formed as a belt 222 circulating around two deflection rollers 220 with the surface of the belt 222 virtually forming the lateral surface of the side limit 210, 212 and the deflection rollers 220 being supported so low in friction that when a vial contacts the belt 222, this belt is moved at the same time in travel direction so that the relative speed between the vial and the belt 222 is reduced to a minimum and the forces acting upon the vial are reduced to a minimum at the same time.

Between the deflection rollers 220 a support roller 224 is provided in order to prevent but at least reduce a bending of the belt 222. In another example (not shown here) also several support rollers may be provided.

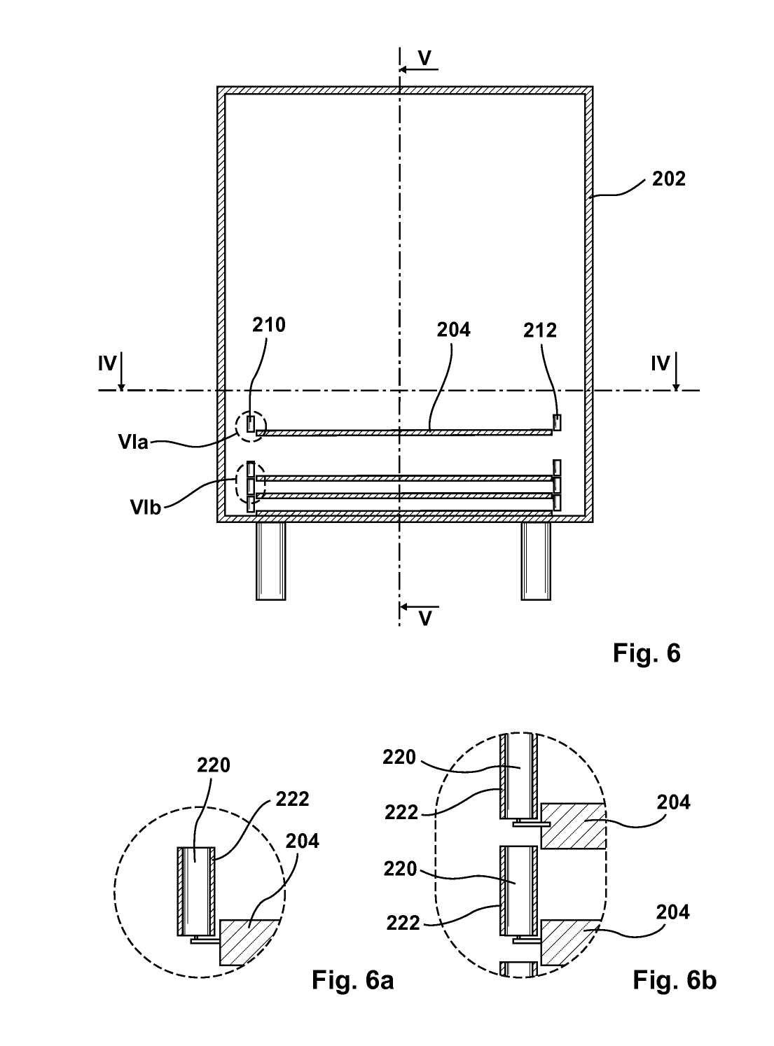

As can be taken in particular from FIGS. 6 a and 6 b, the side limit 212 is arranged here as well next to the adjusting plate 204 so that the adjusting plates 204 can be put together without contacting the side limit 212.

A device formed according to this technical teaching and a freeze-drying apparatus formed according to this technical teaching has the advantage that the movable elements of the side limit offer only minor or no resistance to the striking vials so that friction between the actual side limit and the vials is thus reduced to a minimum. Thus, the vials can slide alongside the side limit without being impeded. As a result, the vials on the border, hence those vials abutting the side limit, can move as quickly and with low friction as all other vials resulting in the fact that the vials among each other keep their order and sequence. This, in turn, has the great advantage that during an inspection of the vials after the terminated freeze-drying process, the location of the insufficiently freeze-dried vials can easily be detected so that rejects can be reduced and possible sources of error are found.

Still another advantage of the movable elements of the side limit is that the vials when striking the side limits now do not experience serious resistance anymore and thus cannot fall over either which leads to a reduction in rejects.

For the side limits attached on the adjusting plate of a freeze-drying apparatus it has proven to be advantageous to attach these on the right and/or left next to the adjusting plate. Thus it is possible to put the adjusting plates arranged one upon the other in a space saving way onto each other in a known manner in order to thus move the required adjusting plate to the opening of the freeze-drying apparatus for loading and unloading.

In a preferred example the movable element of the side limit is a belt circulating in travel direction which is advantageously held via two vertically arranged deflection rollers. These deflection rollers can be attached with low friction so that the circulating belt is set in motion already at the smallest application of a force, thus reducing relative speed between the vial and the belt and/or the side limit to a minimum. By the fact that the circulating belt is virtually likewise running at the same time practically no more forces are exercised on the vials so that also the vials abutting the side limit can be moved with the same speed as all other vials resulting in maintaining the sequence and order of the vials, as has already been described above.

In a more preferred example at least one support roller is provided between the deflection rollers. Due to this support roller, the belt cannot be excessively moved away from the edge of the transfer table and/or the adjusting plate, since otherwise the vial could fall down nevertheless.

In another preferred example the movable element of the side limit comprises a number of vertically arranged hollow cylinders with these hollow cylinders being arranged adjacent to each other so that no vial can fall down between these hollow cylinders. In particular, if these hollow cylinders are supported by an interior pin, they can rotate with low friction around their vertical axis. In this process the hollow cylinders when striking a vial start to rotate so that only little resistance is offered to the vial. By this as well the relative speed between the side limit and the vial is reduced to a minimum.

In a preferred further example the element of the side limit comprise two rows of hollow cylinders arranged on top of each other which are preferably arranged in a staggered manner. This has the advantage that the surface of the side limit facing towards the vials becomes more uniform since due to the hollow cylinders being arranged in a staggered manner the unevennesses are reduced. As a result, the forces occurring on the vials are reduced still further so that the vials abutting the side limits can be moved with almost the same speed as all other vials resulting in maintenance of the order and sequence of the vials.

This application makes reference to, incorporates the same herein by reference, and claims all benefit accruing under 35 U.S.C. §119 from an application filed in the German Patent Office on Dec. 19, 2008, and there assigned Serial No. DE 10 2008 064 094.8.

Further advantages of the inventive freeze-drying apparatus and the inventive device result from the attached drawings and the examples described below. The above mentioned features and the features still described more in detail can also be used according to the invention individually or in any combinations with each other. The examples mentioned are non-limiting examples.

1. A device for loading and unloading of an adjusting plate of a freeze-drying apparatus with a number of vials with a transfer table provided upstream of the freeze-drying apparatus for temporary accommodation of the vials, with a shifting device for shifting the vials from the transfer table onto the adjusting plate or from the adjusting plate onto the transfer table, and with a right and/or left side limit,
characterized in
that the side limit comprises elements which are movable with low friction by the striking vials.

2. A device or freeze-drying apparatus according to claim 1,
characterized in
that the elements are a belt circulating in travel direction.

3. A device or freeze-drying apparatus according to claim 2,
characterized in
that the belt is held via two vertically arranged deflection rollers.

4. A device or freeze-drying apparatus according to claim 3,
characterized in
that between the deflection rollers at least a support roller is provided.

5. A device or freeze-drying apparatus according to claim 1,
characterized in
that the elements comprise a number of vertically arranged hollow cylinders.

6. A device or freeze-drying apparatus according to claim 5,
characterized in
that the hollow cylinders are arranged in a row.

7. A device or freeze-drying apparatus according to claim 5,
characterized in
that the hollow cylinder is supported by an interior pin.

8. A device according to claim 5,
characterized in
that the elements comprise two rows of hollow cylinders arranged on top of each other.

9. A device according to claim 8,
characterized in
that the hollow cylinders are arranged in a staggered manner.

10. A freeze-drying apparatus with a number of vertically movable adjusting plates
characterized in
that on at least one adjusting plate a right and/or left side limit is attached and that the side limit comprises elements which are movable with low friction by the striking vials.

11. A freeze-drying apparatus according to claim 10,
characterized in
that the side limit is attached on the right and/or left adjacent to the adjusting plate.

12. A device or freeze-drying apparatus according to claim 10,
characterized in
that the elements are a belt circulating in travel direction.

13. A device or freeze-drying apparatus according to claim 12,
characterized in
that the belt is held via two vertically arranged deflection rollers.

14. A device or freeze-drying apparatus according to claim 13,
characterized in
that between the deflection rollers at least a support roller is provided.

15. A device or freeze-drying apparatus according to claim 10,
characterized in
that the elements comprise a number of vertically arranged hollow cylinders.

16. A device or freeze-drying apparatus according to claim 15,
characterized in
that the hollow cylinders are arranged in a row.

17. A device or freeze-drying apparatus according to claim 15,
characterized in
that the hollow cylinder is supported by an interior pin.

18. A device according to claim 15,
characterized in
that the elements comprise two rows of hollow cylinders arranged on top of each other.

19. A device according to claim 18,
characterized in
that the hollow cylinders are arranged in a staggered manner.
